(19) United States
(12) Patent Application Publication
(10) Pub. No.: US 2024/0213562 A1
(43) Pub. Date: Jun. 27, 2024

(54) EXTRACTION OF METALS FROM LITHIUM-ION BATTERY MATERIAL

(71) Applicant: METSO FINLAND OY, Espoo (FI)

(72) Inventors: Tuomas VAN DER MEER, Espoo (FI); Marika TIIHONEN, Espoo (FI); Annukka MAKINEN, Espoo (FI); Niko ISOMAKI, Espoo (FI); Roshan BUDHATHOKI, Espoo (FI)

(73) Assignee: METSO FINLAND OY, Espoo (FI)

(21) Appl. No.: 18/555,168

(22) PCT Filed: Apr. 14, 2021
(86) PCT No.: PCT/FI2021/050269

§ 371 Date: Oct. 12, 2023

(51) Int. Cl. H01M 10/54; B09B 3/40; B09B 3/70; B09B 3/80; B09B 101/16; C01B 25/30; C01D 15/02; C01D 15/08; C01G 45/02; C01G 51/10; C01G 53/10; C22B 1/02; C22B 3/00; C22B 3/02; C22B 3/22; C22B 3/46; C22B 7/00; C22B 15/00; C22B 23/00; C22B 26/12; C22B 47/00

(52) U.S. Cl. CPC H01M 10/54; B09B 3/40; B09B 3/70; B09B 3/80; C01B 25/30; C01D 15/02; C01D 15/08; C01G 45/02; C01G 51/10; C01G 53/10; C22B 1/02; C22B 3/02; C22B 3/22; C22B 3/46; C22B 7/007; C22B 15/0013; C22B 15/0067; C22B 15/0091; C22B 23/005; C22B 23/0415; C22B 23/0453; C22B 26/12; C22B 47/00; B09B 2101/16

(57) ABSTRACT

A method for extracting metals from the black mass of lithium-ion batteries, the black mass containing the anode and cathode materials of the batteries as well as some copper, and the cathode material comprising lithium and nickel. The method of extracting metals carried out by an arrangement that is suitable for use in the method.

### BACKGROUND OF THE INVENTION

### Field of the Invention

The present invention relates to a method for extracting metals from lithium-ion battery material, particularly from the black mass obtained from said battery material, containing cathode metals and anode material, as well as copper originating from the battery components, the cathode metals typically comprising lithium and nickel, further possible cathode metals being cobalt, manganese and aluminium. The invention also relates to an arrangement that is suitable for use in the method.

### Description of Related Art

The use of lithium-ion batteries has grown steadily for the last years and even decades, and their importance appears to grow even further as the development of new electric vehicles continues.

Such lithium ion batteries contain, in their cathodes, several transition metals that can be valuable when recovered from these batteries, either for reuse in batteries or for other purposes. Separating the cathode material from the other battery components typically begins with a mechanical removal of solids, such as copper foil, from the battery material, followed by a washing step to further remove the electrolyte. The remaining cathode and anode materials form a so-called black mass, which is suitable for treatment by a hydrometallurgical separation process to recover the desired individual metals.

However, the mechanical separation is not fully selective, whereby fractions of the copper (e.g. from said copper foil) ends up in the black mass, and when the hydrometallurgical separation process involves a leaching step to solubilize the transition metals of the cathode, the copper is also dissolved. This copper fraction is typically big enough to raise interest of recovery as a pure copper product.

The removal of copper from the solution is important, since any copper remaining in the solution will end up as an impurity in the product fractions of the transition metals. However, the effective removal of copper is difficult.

The most typical approach for copper (Cu) recovery is solvent extraction, which can selectively recover the Cu into a concentrated Cu sulphate solution, which can then be made into a new Cu product, such as a Cu cathode, by electrowinning. This approach is, however, complex, brings in excess chemicals to the process feed, and causes a significant increase in investment requirements.

A simpler and more cost-effective approach, resulting in metal products of higher purity, would be utilizing copper cementation, which is a well-known and also selective method for recovering copper. It has, however, not been used to any significant degree in the recovery of metals from battery materials, which can form quite complex metal mixtures.

Thus, there is an existing need for new techniques for providing an efficient recovery of selected metals, individually, and in pure form, from complex mixtures of cathode and other metals.

### SUMMARY OF THE INVENTION

The invention is defined by the features of the independent claims. Some specific embodiments are defined in the dependent claims.

According to a first aspect of the present invention, there is provided a method for extracting metals from the black mass obtained from lithium-ion battery material, the black mass containing the anode and cathode materials of the batteries, as well as copper metal. The metals that are extracted and recovered include the copper, as well as transition metals from the battery cathode, such as lithium and nickel, as well as possibly one or both of cobalt and manganese.

According to a second aspect of the invention, there is provided a method for extracting metals from the black mass, proceeding via the solubilisation of the desired metals of the black mass, followed by the recovery of such solubilised metal fractions from an obtained solution, together with further soluble metal fractions.

According to a third aspect of the invention, there is provided a method that proceeds via the recovery of a copper fraction from an obtained solution containing solubilized cathode material, using a cementation with a reagent that can be efficiently separated from the remaining solution.

According to a further aspect of the invention, there is provided an arrangement suitable for use in carrying out the steps of the method of the invention.

The method of the invention thus comprises
one or more leaching steps, and
the metal separation steps required to recover the desired metals from the leach solution, typically as a copper fraction as well as fractions including lithium, and nickel ions, the copper recovery step including a copper cementation using nickel as reducing agent.

Likewise, the arrangement of the invention, suitable for use in the above described method, comprises
one or more leaching units, from which a leach solution containing the dissolved cathode material is recovered, and
metal separation units, from which fractions including copper, as well as lithium and nickel ions are recovered, the copper recovery including a cementation unit.

Thus, the invention is based on the recovery of copper (Cu) from a solution containing impurities, as well as a mixture of metal ions including, in addition to the Cu, at least nickel (Ni).

At least a part of the copper recovery takes place by cementation, which results in a replacement of the Cu in solution with Ni, thus giving a Cu metal product, which can easily be separated from the components of the solution. The cementation reaction is based on the nickel reagent having a higher, or more negative, reduction potential (−0.25 V) than the reduction potential of copper (0.34 V). The selectivity of the nickel reagent is, in turn, partly based on the fact that the reduction potentials of the other elements present in the leach solution, such as the lithium (−3.04 V), or possibly that of the cobalt (−0.28 V), manganese (−1.19 V) or aluminium (−1.66), are more negative than that of the nickel reagent, whereby these other elements will not be reduced.

The present invention provides several advantages. Among others, the inventors have found that process configuration needed for cementation is a significantly simpler and hence more cost effective solution for the recovery of copper from black mass leach solutions obtained from Li ion batteries, compared for example to the solvent extraction followed by electrowinning that is commonly used in battery recycling applications. Such simple process configurations are of particular advantage when processing complex material mixtures, such as lithium ion battery materials.

Further, the cementation introduces a procedure, where the copper is recovered without contaminating the leach solution with further chemicals, but by simply increasing the content of a further metal in the solution, in this case nickel, which further metal can subsequently be recovered separately. The lack of further added chemicals also results in the possibility to recover the other metals of the leach solution individually.

Utilizing such an efficient copper recovery will also result in a selective overall process for the recovery of metals from black mass, which will provide individual metal products in high yield and high purity. Thus, the copper cementation will provide a synergy that results in high-purity metal products.

### BRIEF DESCRIPTION OF THE DRAWINGS

FIG. 1 is a diagram illustrating the units of the arrangement according to the invention;

FIGS. 2A and 2B, as well as FIG. 3 and FIG. 4 are diagrams illustrating the units of arrangements according to embodiments of the invention.

### EMBODIMENTS OF THE INVENTION

### Definitions

In the present context, the term “black mass” is intended to describe the mixture of cathode and anode material that is obtained after a mechanical separation of the macro components of batteries, the black mass also containing copper in metallic form originating, among others, from the copper foil of the batteries, as well as organic compounds depending on the black mass pre-treatment method, such as the compounds originating from the electrolyte of the batteries.

“Organic compounds” are herein intended to encompass molecules, where one or more atoms of carbon are covalently linked to one or more atoms of hydrogen, oxygen or nitrogen. Thus, e.g. graphite or other allotropes of pure carbon, are excluded from this group of compounds. Other compounds commonly considered to be excluded from this class of compounds, despite fulfilling the definition, include carbonates and cyanides, if the only carbon of the compound is based in this group, as well as carbon dioxide.

The “anode” is typically formed of mainly graphite or silicon, which are not solubilized in the leaching of the invention, but are present in the black mass before leaching.

The “cathode material” or “cathode metals”, in turn, encompass metal ions, such as lithium, nickel, cobalt and manganese (Li, Ni, Co and Mn), typically in the form of their oxides. The contents of these metals in the black mass are preferably all within the range of 1-35% by weight. Other examples of cathode components that may be present in the black mass, usually however present in smaller amounts, include tin, zirconium, zinc, copper, iron, fluoride, phosphorus and aluminium (i.e. Sn, Zr, Zn, Cu, Fe, F, P and Al).

The present invention relates to a method for extracting metals from the black mass of lithium-ion battery material. The method comprises the following steps:
a) one or more pre-treatment steps, wherein a fraction of non-metallic material is separated from the black mass, and a pre-treated black mass containing anode and cathode materials is recovered, and preferably treated further by leaching,
b) one or more leaching steps, wherein cathode material of the pre-treated black mass is dissolved, and a leach solution containing the dissolved cathode material is recovered, and preferably treated further by separating metallic fractions therefrom, and
c) metal separation steps, wherein one or more initial fractions of metallic material is separated from the leach solution, and main fractions including at least nickel and lithium, are recovered,
   i) whereby the metal separation steps comprise a step for recovering copper, including a cementation of the copper using nickel as reducing agent, and carried out before the nickel of the leach solution is recovered,
   ii) whereby the nickel is recovered after the copper recovery, but before the lithium recovery, and
   iii) whereby the nickel is recovered by solvent extraction.

The black mass of lithium ion batteries typically contains both cathode and anode materials, as well as some copper and electrolyte materials with organic compounds. The organic compounds are preferably removed by the above mentioned pre-treatment step(s). For example, one or more washing steps can be used, each preferably carried out by mixing the battery material with water or an organic solvent, most suitably with water, whereby material that is dissolved or dispersed in said solvent, such as said organic compounds, can be separated from the undissolved components of the black mass. Alternatively, one or more heating steps, typically carried out as pyrolysis or evaporation steps, can be used to remove organic compounds, each preferably carried out at a temperature of 195-470° ° C. One option is also to carry out both washing step(s) and heating procedure(s).

The pre-treatment step(s) thus yield a pre-treated black mass that preferably contains the lithium and nickel, and possibly also the manganese and cobalt, of the battery cathode, in oxide form, as well as remaining metallic copper, and more preferably contains <3% by weight of organic compounds, most suitably <1.5% by weight.

In a preferred embodiment of the invention, at least a fraction of the lithium typically lost in the optional washing steps is recovered by
a step of reacting the used washing solution, separated from the remaining solids and containing the separated fraction of non-metallic material, with a phosphate reagent, to cause precipitation of the lithium therein into lithium phosphate, and
a step of separating the lithium phosphate precipitate from the remaining washing solution and combining it with the pre-treated black mass that is carried to the following leaching step(s).

After the pre-treatment step(s), a solid/liquid separation is typically carried out, whereby the pre-treated black mass can be carried to the following leaching step, and optionally be mixed with added metal-containing solids or slurry, such as a lithium phosphate precipitate recycled from either the pre-treatment steps or the metal recovery steps.

In an embodiment of the invention, at least one leaching step is operated with the addition of acid and one or more leaching reagents. Typically, only one leaching step is used, which is said acid leaching step. The acid leaching is preferably carried out by dispersing the pre-treated black mass into a solution containing the acid, and adding optional extractants, preferably followed by mixing.

The acid used in the leaching step(s) is preferably selected from hydrochloric acid, nitric acid, methanesulfonic acid, oxalic acid, citric acid and sulphuric acid, thus forming an acidic leach solution. Further, the leaching is preferably carried out in the presence of one or more leaching reagent(s) or extractants, more preferably being selected from hydrogen peroxide, a carbohydrate and sulphur dioxide, due to their reductive capabilities, providing a more effective dissolution.

The temperature during the leaching step is preferably adjustable, whereby the temperature most suitably is maintained at an elevated level during the acid leaching, such as a temperature of >50° C., preferably a temperature of 50-95° C., and more preferably a temperature of 60-90° C. Similarly, the pressure during the acid leaching is preferably maintained at atmospheric pressure, or slightly elevated pressure of 100-200 kPa. Typically, the solubilisation of the desired transition metals is complete within a time of 2-6 hours.

After the leaching reaction is complete, i.e. after the pre-treated black mass has spent a sufficient amount of time, such as 2-6 hours, in the leaching conditions, a solid/liquid separation is typically carried out, in order to recover the leach solution containing the cathode metals, whereby it can be carried to the following step of the method, for recovery of separate metallic fractions.

In an embodiment of the invention, the step(s) for recovering at least nickel and lithium ions, as said main fractions, are preceded by the one or more steps for separating initial fractions of metallic material from the leach solution (or “initial metallic fractions”), said initial fractions of metallic material including at least one of iron, aluminium, calcium and fluoride ions, and possible phosphates. This order of steps has the advantage of providing a purified solution for the recovery of the main fractions of metallic material, since the initial fractions include the materials that are considered to belong to the impurities. These materials would also impair the subsequent recoveries of the main fractions, or at least result in lower purity or lower yields, if left in the leach solution.

Typically, the separation(s) of initial fractions of metallic material include at least one step carried out as a solvent extraction (SX), intended to remove said impurities, such as iron and aluminium, from the leach solution, optionally preceded by a solid separation, to remove any impurities already in solid form, thus increasing the selectivity and performance of the solvent extraction.

In another alternative, the separation(s) of initial fractions of metallic material include at least one step carried out as a precipitation, for example a hydroxide precipitation, intended to remove impurities, such as iron and aluminium, and possible phosphates, as a solid fraction from the leach solution.

In a particularly preferred alternative, the separation of initial fractions of metallic material includes a precipitation, with an optional separation of the precipitated impurities, followed by a solvent extraction, both steps as described above. The advantage of such a two-step impurity separation is that the contents of impurities, such as iron and aluminium, are further decreased in the thus purified leach solution. It is particularly preferred to carry out the precipitation before the solvent extraction in such a two-step separation of initial metallic fractions, since this will facilitate a high selectivity in the solvent extraction.

The copper recovery step is preferably carried out before any other metal separation steps are carried out, thus before the separation(s) of initial fractions of metallic material, since copper can have a negative impact on the subsequent separations and recoveries while copper itself may also be lost during those steps. Likewise, the cementation utilized in the copper recovery is a selective reaction, which will yield a pure copper product despite impurities being present, whereby there is no need to purify the leach solution before the copper recovery takes place.

Since at least one leaching step has been carried out in acidic conditions, the copper recovery preferably also endures said conditions.

The copper recovery from the leach solution is typically carried out either by said cementation step using nickel as reducing agent, or by a solvent extraction followed by said cementation, whereby the obtained copper-deprived solution is carried to the following metal separation step. The nickel used in the cementation is typically metallic nickel in powder form. The reaction (1) taking place during the cementation is thus:

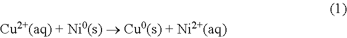

Thus, the cementation reaction will yield copper in solid form, typically recovered as a powder. The obtained copper powder is preferably separated from the solution after recovery, potentially by settling, followed by filtration that can include a washing step to remove the mother liquid.

As discussed above, the cementation has the advantage of introducing a procedure, where the copper is recovered without contaminating the transition metal-containing solution with further chemicals, but by simply increasing the content of a selected metal in the solution, in this case of nickel, which selected metal can subsequently be recovered separately. Since this selected metal, nickel, is one that is already present in the black mass and subsequently in the leach solution, no further steps are added to the overall method. This procedure merely increases the amount of nickel to be recovered.

The solvent extraction that optionally is combined with the cementation has the further advantage of increasing the yield of recovered copper, thus leaving only insignificant levels of copper-impurities in the solution carried to the following metal recoveries. This will, in turn, result in higher purity of the metals recovered subsequently.

Various reactions and procedures can be utilized to carry out the remaining metal separations and recoveries, such as further leaching or washing steps, solvent extractions, precipitations, ion exchange steps, and electrowinning steps. However, it is preferred to utilize at least one solvent extraction for the separations of the initial fractions of metallic material, as mentioned above, since this will result in a higher purity of the remaining solution, thus also facilitating the subsequent recoveries of the main fractions, particularly the recovery of cobalt and nickel, whereby all of the metals of the main fractions can be recovered in high yield and high purity, typically as battery-grade materials.

As mentioned above, the recoveries of the main fractions of metals include steps for recovering at least nickel, since further nickel has been added to the copper-deprived leach solution in the cementation step, and nickel is thus present in said solution at an increased content. Other metals of the main fractions include, as stated above, lithium, and possibly cobalt and manganese.

The nickel is thus recovered from a copper-deprived leach solution, the nickel recovery thus carried out at a later stage of the method than the copper recovery, and also at a later stage than the separation of the initial metallic fractions.

Preferably, this nickel recovery takes place either simultaneously with or directly after the optional recovery of cobalt, more preferably after the cobalt is recovered, and most suitably before any lithium is recovered. Typically, this nickel recovery also takes place at a later stage than an optional manganese recovery.

Said nickel recovery can be carried out, for example, using a solvent extraction (SX), which produces a rather pure nickel sulphate solution (NiSO₄). This solution is optionally purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for nickel recovery is most suitably carried out using extraction chemicals having a carboxylic acid functional group, one commercial example of suitable extraction chemicals being Versatic™ 10, which is a neodecanoic acid.

In an embodiment of the invention, the metal separation steps also include a step for recovering cobalt from a copper-deprived leach solution, the cobalt recovery thus carried out at a later stage than the copper recovery, and also at a later stage than the separation of the initial metallic fractions.

Preferably, the cobalt recovery takes place either simultaneously with or directly before the recovery of nickel, more preferably before the nickel is recovered, and most suitably also before any lithium is recovered. Typically, this cobalt recovery, however, takes place at a later stage than an optional manganese recovery.

A preferred option for said cobalt recovery is a solvent extraction (SX), which produces a rather pure cobalt sulphate solution (CoSO₄). This solution is optionally purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for cobalt recovery is most suitably carried out using extraction chemicals having a carboxylic acid functional group, such as the phosphinic acid functional group, one example of suitable extraction chemicals being Cyanex™ 272, which is also known as trihexyltetradecylphosphonium bis(2,4,4-trimethylpentyl)phosphinate.

In a further embodiment of the invention, the metal separation steps include a step for recovering manganese from a copper-deprived leach solution, the manganese recovery thus carried out at a later stage of the method than the copper recovery, and also at a later stage than the separation of the initial metallic fractions.

Preferably, the manganese recovery is carried out before the nickel or the cobalt is recovered, and most suitably before any of the nickel, cobalt and lithium are recovered.

Options for said manganese recovery include solvent extractions and precipitations, or a solvent extraction followed by a precipitation. One particularly preferred option is to utilize an oxidative precipitation using sulphur dioxide, SO₂, and air, to form the manganese oxide, MnO₂.

In a further embodiment of the invention, the metal separation steps include a step for recovering lithium from a copper-deprived leach solution, the lithium recovery thus carried out at a later stage of the method than the copper recovery, and also at a later stage than the separation of the initial metallic fractions.

Preferably, the lithium recovery is carried out after any of the manganese, cobalt, and nickel present in the leach solution have been recovered. Using this preferred order of steps will result in a situation, where the lithium can be recovered from a high-purity lithium-containing solution.

Typically, the lithium is recovered by reacting the lithium into its carbonate or phosphate, producing a product fraction that can be recovered as such, or alternatively be further converted into e.g. lithium hydroxide, which can then be crystallized into pure hydroxide crystals.

A further option for the lithium recovery is to use a solvent extraction, after which a further conversion or crystallization can be carried out. The benefit of this procedure is an even higher lithium recovery.

In an embodiment of the invention, the lithium is recovered into its carbonate, producing a product fraction that can be recovered by a solid/liquid separation, and the solid product fraction be collected as such, or alternatively be further converted into e.g. lithium hydroxide. The liquid fraction can, in turn, be reacted further with a phosphate reagent, and possibly a separate precipitation reagent, thus causing precipitation of the lithium remaining therein into a lithium phosphate precipitate. This precipitate can be carried either to the lithium recovery, e.g. by combining it with the carbonate or phosphate product fraction, or it can be recycled to the leaching step, by mixing it with the pre-treated black mass. A further option is to carry a fraction of the precipitate to each of these.

The phosphate reagent used above can be selected from any phosphates of alkali or earth alkali metals. However, sodium phosphate (Na₃PO₄) is preferred, since it brings no new cations to the reaction mixture, and since it has a suitable reactivity.

The optional precipitation reagent is preferably selected from alkaline agents, such as sodium hydroxide, functioning by increasing the pH of the solution, thus facilitating the precipitation of the desired lithium phosphate.

The method of the invention can be carried out in any suitable apparatus or arrangement, with the units and equipment needed to carry out the steps of the method.

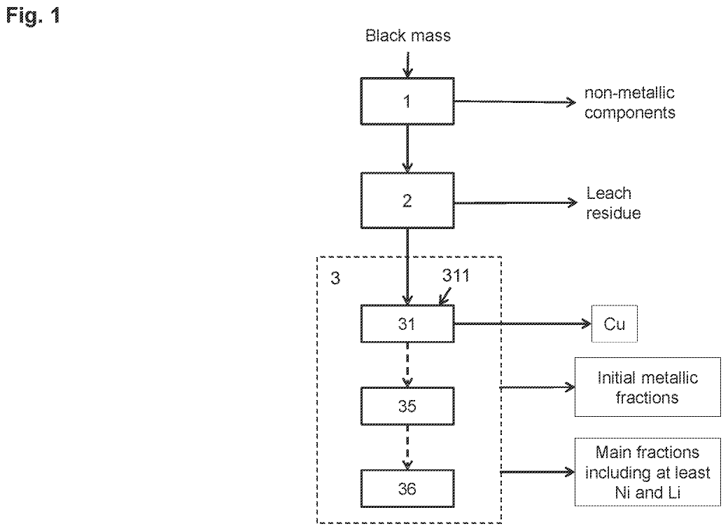

The present invention further relates to an arrangement suitable for use in the above described method. Said arrangement comprises the following units (see FIG. 1):
one or more pre-treatment units 1 for separating a fraction of non-metallic components from the black mass, and recovering a pre-treated black mass containing the anode and cathode materials, preferably intended to be conducted via suitable connections to a downstream leaching unit 2,
one or more leaching units 2 for dissolving cathode material of the pre-treated black mass and recovering a leach solution containing said dissolved cathode material, preferably intended to be conducted via suitable connections to a downstream separation unit 3,
metal separation units 3 for separating one or more initial fractions of metallic material from the leach solution and recovering main fractions including at least nickel and lithium,
   whereby the metal separation units 3 further include a copper separation unit 31, including or consisting of a cementation unit, the copper separation unit 31 being equipped with a nickel inlet 311 and positioned upstream from any unit 35 intended for nickel recovery,
   whereby a unit 35 for recovering nickel is positioned downstream from the copper separation unit 31 and upstream from a lithium recovery unit 36, and
   whereby the unit 35 for recovering nickel includes a subunit for solvent extraction.

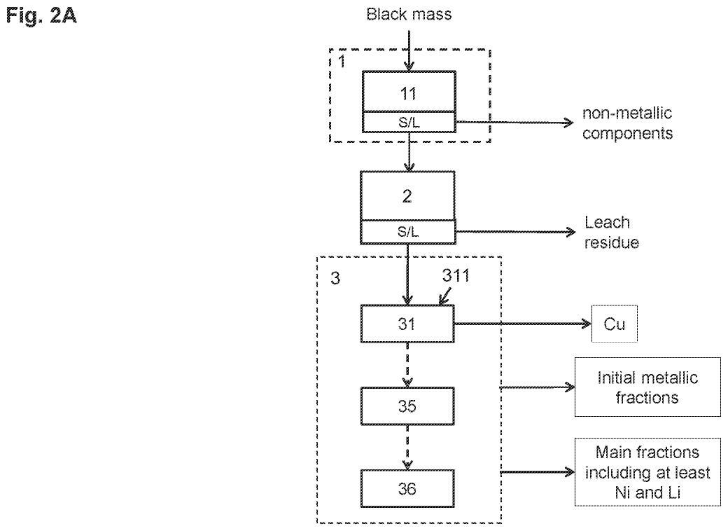

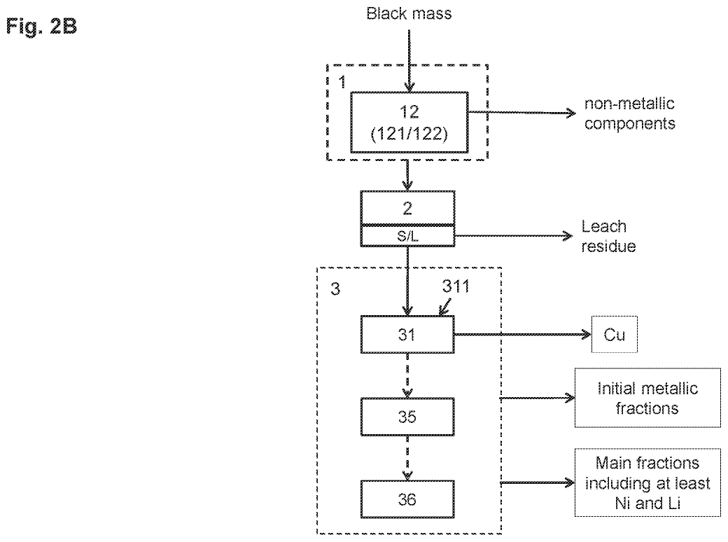

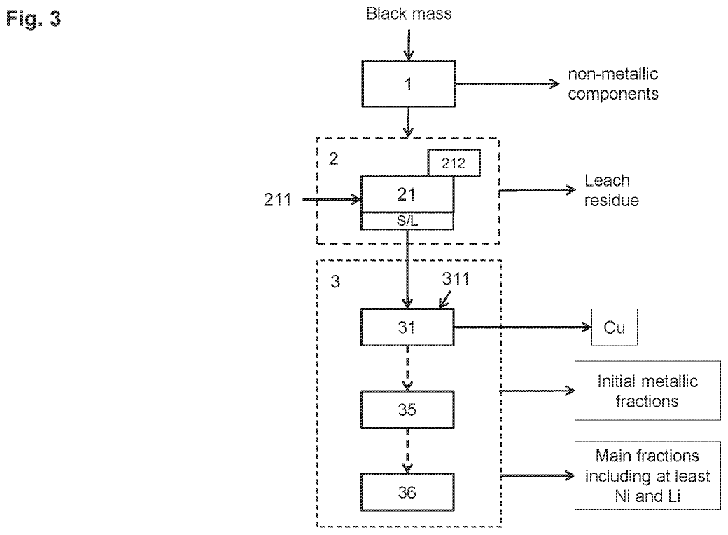

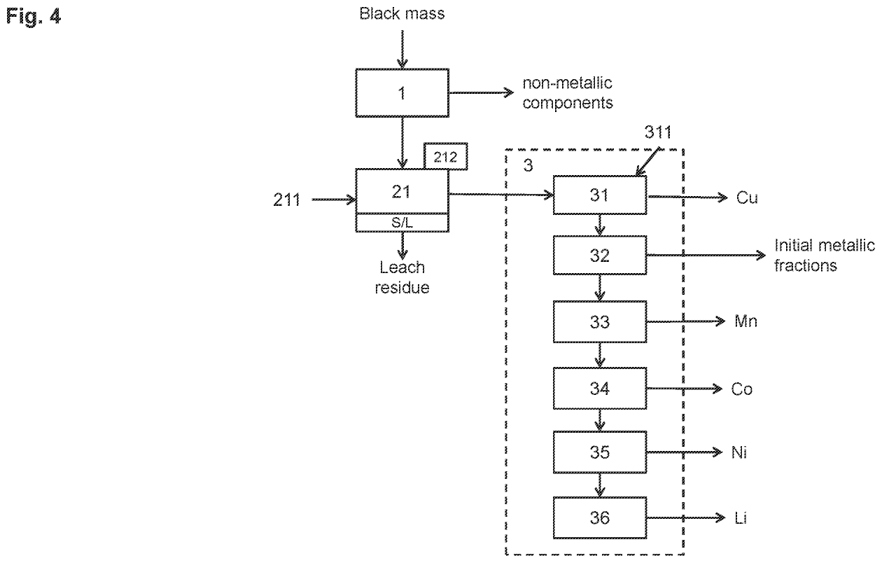

In an embodiment of the invention, with various options shown in FIGS. 2A and 2B, the pre-treatment unit(s) 1 include a washing unit 11 or a heating unit 12, or both, for removing non-metallic components, such as organic compounds, from the black mass, the heating unit 12 most suitably selected from a pyrolysis unit 121 or an evaporation unit 122. The optional washing unit 11 is preferably further equipped with a water inlet

The leaching unit(s) 2 typically consist of said acid leaching unit(s) 21, which in turn is equipped with the required inlets 211 for acid and optional extractants, as well as preferably means 212 for adjusting the temperature, which can incorporate either heating or cooling, as shown in FIGS. 3 and 4.

The metal separation units 3 preferably include several subunits, all subunits typically equipped with the further subunits, inlets and outlets needed to carry out the reactions they are intended for. In addition to the units 31, 35, 36 for recovering copper, nickel and lithium, respectively, also other separation and recovery units can be included in the metal separation units 3, as illustrated by FIG. 4.

Preferably, one or more units 33, 34, 35, 36 for recovering main fractions of metallic material, including at least nickel and lithium ions, and possibly cobalt and manganese ions, are preceded by one or more units 32 for separating initial fractions of metallic material from the leach solution.

Preferably, the copper separation unit(s) 31 is positioned upstream from said units 32 for separating the initial metallic fractions, the latter units 32 most suitably including at least one solvent extraction unit.

The copper powder obtained from the copper separation unit(s) 31 is typically separated from the solution after recovery. For this purpose, the arrangement preferably contains a subunit for settling the powder, and a subsequent solid/liquid separation subunit, such as a clarifier, hydrocyclone, decanter or filter, or more than one of these.

Various types of equipment can be utilized to carry out said separations and recoveries, such as further leaching or washing units, solvent extraction units, precipitation units, ion exchange units, and electrowinning units. However, solvent extraction units are preferred. Particularly, it is preferred to utilize at least one solvent extraction unit for the separations of the initial metallic fractions. More preferably, the solvent extraction is preceded by a solid separation unit, which, in turn, optionally is preceded by a precipitation unit for such impurities.

The units 33, 34, 35, 36 for recovering the main fractions thus include units 35, 36 for recovering at least nickel and lithium ions, and possibly separate subunit(s) 33, 34 for recovering manganese and cobalt ions.

The unit(s) 34, 35 for recovering nickel and cobalt are either combined or separate, preferably being separate, with the cobalt recovery unit 34 upstream from the nickel recovery unit 35, thus providing the necessary equipment to yield individual, pure metal products.

Said unit(s) 34, 35 for recovering nickel and cobalt preferably include solvent extraction unit(s), more preferably connected to crystallization unit(s), to yield pure product crystals.

The unit 36 for recovering lithium is, in turn, preferably positioned downstream from all other metal separation units 31, 32, 33, 34, 35, and typically includes one or two subunits for conversion of the lithium into a form that can be recovered in high yield.

The optional manganese recovery unit 33 is preferably positioned upstream from the units 34, 35, 36 for recovering cobalt, nickel and lithium, and typically includes one or both of a solvent extraction subunit and a precipitation subunit.

It is particularly preferred that the arrangement of the above described embodiments is configured to be suitable for use in the method of the invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

### INDUSTRIAL APPLICABILITY

The present method, and the arrangement suitable for use in said method, can be used to replace conventional alternatives for recovery of metals from the black mass obtained from lithium-ion batteries.

In particular, the present method and arrangement provides an economical and efficient procedure for recovering copper, nickel and lithium, as well as possibly cobalt and manganese, in good yields from such battery material.

### REFERENCE SIGNS LIST

As shown in the Figures (see FIGS. 1-4), the following units and lines can be included in the arrangement of the present invention, according to one or more embodiments of the invention:
1 Pre-treatment unit, including or consisting of:
   11 Washing unit
   12 Heating unit, e.g. in the form of
      121 Subunit for pyrolysis
      122 Subunit for evaporation
2 Leaching unit, typically with a solid/liquid separation unit, the leaching unit including or consisting of:
   21 Acid leaching unit, including:
      211 Inlet for acid or further leaching reagent
      212 Means for adjusting the temperature
3 Metal separation units, including:
   31 Copper ion separation unit
      311 Nickel inlet
   32 Unit for separating initial fraction(s) of metallic material
   33 Optional unit for recovering manganese
   34 Optional unit for recovering cobalt
   35 Unit for recovering nickel
   36 Unit(s) for recovering lithium

1. A method for extracting metals from the black mass of lithium-ion batteries, the black mass containing the anode and cathode materials of the batteries as well as some copper, and the cathode material comprising lithium and nickel, the method comprising the following steps:
a) one or more pre-treatment steps, wherein a fraction of non-metallic material is separated from the black mass, and a pre-treated black mass containing anode and cathode materials is recovered,
b) one or more leaching steps, wherein cathode material of the pre-treated black mass is dissolved, and a leach solution containing the dissolved cathode material is recovered, and
c) metal separation steps, wherein one or more initial fractions of metallic material is separated from the leach solution, and main fractions including at least nickel and lithium are recovered,
i) whereby the metal separation steps include a step for recovering copper, including a cementation of the copper using nickel as reducing agent, and carried out before the nickel of the leach solution is recovered,
ii) whereby the nickel is recovered after the copper recovery, but before the lithium recovery, and
iii) whereby the nickel is recovered by solvent extraction.

2. The method according to claim 1, which is used to extract metals from black mass, wherein the cathode material comprises the lithium and the nickel, and optionally one or more of manganese, cobalt and aluminium, in oxide form.

3. The method according to claim 1, which is used to extract metals from black mass, which contains copper in metallic form.

4. The method according to claim 1, wherein the pre-treatment step(s) include one or more steps of washing or heating, or both, the heating preferably carried out to provide a pyrolysis or an evaporation.

5. The method according to claim 1, wherein the pre-treatment step(s) are carried out to cause separation of non-metallic components, such as organic compounds, from the black mass, thus resulting in a pre-treated black mass containing <3% by weight of organic compounds, preferably <1.5% by weight.

6. The method according to claim 1, wherein at least one leaching step is operated with the addition of acid and one or more leaching reagents, the acid preferably being selected from hydrochloric acid, nitric acid, methanesulfonic acid, oxalic acid, citric acid and sulphuric acid, thus forming an acidic leach solution, and the leaching reagent(s) preferably being selected from hydrogen peroxide, a carbohydrate and sulphur dioxide.

7. The method according to claim 1, wherein the step(s) for recovering at least nickel and lithium ions, as said main fractions, are preceded by the one or more steps for separating initial fractions of metallic material from the leach solution.

8. The method according to claim 1, wherein the initial fractions of metallic material include at least one of iron, aluminium, calcium and fluoride ions, and optionally phosphate ions.

9. The method according to claim 1, wherein the separation(s) of initial fractions of metallic material include at least one step carried out as a solvent extraction, intended to remove impurities, such as iron and aluminium, from the leach solution, optionally preceded by a solid separation, to remove any solid impurities and increase the selectivity of the solvent extraction.

10. The method according to claim 1, wherein the separation(s) of initial fractions of metallic material include at least one step carried out as a precipitation, intended to remove impurities, such as iron and aluminium, as well as phosphates that might be present, from the leach solution, preferably followed by a solvent extraction.

11. The method according to claim 1, wherein copper is recovered from the leach solution before the separation(s) of initial fractions of metallic material.

12. The method according to claim 1, wherein copper is recovered from the leach solution by said cementation step using nickel as reducing agent, or by a solvent extraction followed by the cementation, whereby the obtained copper-deprived solution is carried to the following metal separation step.

13. The method according to claim 1, wherein metallic nickel in powder form is used in the copper cementation.

14. The method according to claim 1, wherein the nickel originating from both the leach solution and from the copper cementation is recovered by solvent extraction, which produces a nickel sulphate solution (NiSO₄), preferably using extraction chemicals having a carboxylic acid functional group, one commercial example of suitable extraction chemicals being Versatic™10, which is a neodecanoic acid.

15. The method according to claim 1, wherein the nickel originating from both the leach solution and from the copper cementation is recovered by solvent extraction that produces a nickel sulphate solution, which solution is utilized as such, or it is purified further, e.g. by ion exchange and optionally a crystallization, or it is precipitated into a hydroxide or a carbonate.

16. The method according to claim 1, wherein the metal separation steps include a step for recovering cobalt from the copper-deprived leach solution, the cobalt recovery carried out either simultaneously with or directly before the recovery of nickel, preferably directly before the recovery of nickel.

17. The method according to claim 1, wherein the metal separation steps include a step for recovering cobalt from the copper-deprived leach solution, the cobalt recovery carried out by solvent extraction, which produces a cobalt sulphate solution (CoSO₄), preferably using extraction chemicals having a carboxylic acid functional group, such as the phosphinic acid functional group, one example of suitable extraction chemicals being Cyanex™272, which is also known as trihexyltetradecylphosphonium bis(2,4,4-trimethylpentyl)phosphinate.

18. The method according to claim 1, wherein the metal separation steps include a step for recovering cobalt from the copper-deprived leach solution, the cobalt recovery carried out by solvent extraction that produces a cobalt sulphate solution, which solution is utilized as such, or it is purified further, e.g. by ion exchange and optionally a crystallization, or it is precipitated into a hydroxide or a carbonate.

19. The method according to claim 1, wherein lithium is recovered after any recoveries of manganese, cobalt, and nickel present in the leach solution have been carried out, the lithium being recovered e.g. by reacting the lithium with a carbonate or a phosphate reagent, optionally followed by a further conversion, an evaporation or a crystallization

20. The method according to claim 1, wherein the metal separation steps include a step for recovering manganese from a copper-deprived leach solution, thus carried out after the copper separation, and preferably carried out before any recoveries of nickel or cobalt have taken place, more preferably before any recoveries of cobalt, nickel or lithium have taken place, the manganese recovery carried out e.g. by solvent extraction or precipitation, or by a solvent extraction followed by a precipitation.

21. An arrangement for extracting metals from the black mass of lithium-ion batteries, the black mass containing the anode and cathode materials of the batteries, wherein the cathode material comprises lithium and nickel, the arrangement comprising:
one or more pre-treatment units for separating a fraction of non-metallic components from the black mass, and recovering a pre-treated black mass containing the anode and cathode materials,
one or more leaching units for dissolving cathode material of the pre-treated black mass and recovering a leach solution containing said dissolved cathode material,
metal separation units for separating one or more initial fractions of metallic material from the leach solution and recovering main fractions including at least nickel and lithium,
whereby the metal separation units further include a copper separation unit, including or consisting of a cementation unit, the copper separation unit being equipped with a nickel inlet and positioned upstream from any unit intended for nickel recovery,
whereby an unit for recovering nickel is positioned downstream from the copper separation unit and upstream from a lithium recovery unit, and
whereby the unit for recovering nickel includes a subunit for solvent extraction.

22. The arrangement according to claim 21, wherein the pre-treatment unit(s) include a washing unit or a heating unit, or both, for removing non-metallic components, such as organic compounds, from the black mass, the heating unit preferably being selected from a pyrolysis unit or an evaporation unit.

23. The arrangement according to claim 21, wherein the metal separation units include units for recovering at least nickel and lithium ions, and possibly further unit(s) for recovering manganese and cobalt ions, all recovery units preferably positioned downstream from one or more units for separating the initial fraction(s) of metallic material from the leach solution, most suitably including at least one solvent extraction unit.

24. The arrangement according to claim 21, wherein the copper separation unit is positioned upstream from unit(s) for separating the initial metallic fractions from the leach solution.

25. The method according to claim 1, which is carried out using the arrangement of claim 21.
